(19) United States
(12) Patent Application Publication
(10) Pub. No.: US 2008/0233436 A1
(43) Pub. Date: Sep. 25, 2008

(54) DIFFUSION MEDIA TAILORED TO ACCOUNT FOR VARIATIONS IN OPERATING HUMIDITY AND DEVICES INCORPORATING THE SAME

(75) Inventor: Jeanette E. Owejan, Honeoye, NY (US)

Correspondence Address: DINSMORE & SHOHL LLP, ONE DAYTON CENTRE, ONE SOUTH MAIN STREET, SUITE 1300, DAYTON, OH, 45402, US

(73) Assignee: GENERAL MOTORS CORPORATION, Detroit, MI (US)

(21) Appl. No.: 12/056,611

(22) Filed: Mar. 27, 2008

Related U.S. Application Data
(63) Continuation-in-part of application No. 10/628,316, filed on Jul. 28, 2003.

(51) Int. Cl. H01M 8/02

(52) U.S. Cl. 429/12

(57) ABSTRACT

A diffusion media and a scheme for tailoring the parameters of the diffusion media are provided for addressing issues related to water management in electrochemical cells and other devices employing the diffusion media. Various parameters of the diffusion media are tailored to the specific operational humidity of the fuel cell.

### CROSS-REFERENCE TO RELATED APPLICATIONS

This application is a continuation-in-part of U.S. patent application Ser. No. 10/628,316, filed Jul. 28, 2003 (GP 303 569/GMC 0048 PA).

Additionally, this application is related to commonly assigned U.S. patent application Ser. No. 10/628,318 (GP 303 556/GMC 0047 PA), filed Jul. 28, 2003, now allowed, and Ser. No. 10/628,856 (GP 303 447/GMC 0051 PA) filed Jul. 28, 2003, now U.S. Pat. No. 6,967,039, the disclosures of which are incorporated herein by reference. The present application is also related to commonly assigned U.S. patent application Ser. No. 10/685,346 (GP 302 361/GMC 0011 PA), filed Oct. 14, 20003, now allowed.

### BACKGROUND OF THE INVENTION

The present invention relates to the design and manufacture of diffusion media and, more particularly, to diffusion media for use in electrochemical cells where water management is a significant design issue.

### BRIEF SUMMARY OF THE INVENTION

According to the present invention, a diffusion media and a scheme for tailoring the parameters of the diffusion media are provided for addressing issues related to water management in electrochemical cells and other devices employing the diffusion media. In accordance with one embodiment of the present invention, a device configured to convert a hydrogenous fuel source to electrical energy is provided. The device comprises a first reactant input, a second reactant input, a humidified reactant output, a diffusion media configured to pass multiphase reactants within the device, and a controller configured to operate the device at high relative humidity. The controller is configured such that operating conditions of the electrochemical cell are adjusted to produce a relative humidity of the humidified reactant output exceeding about 150%. The diffusion media comprises a diffusion media substrate and a mesoporous layer. The diffusion media substrate comprises a carbonaceous porous fibrous matrix defining first and second major faces. The mesoporous layer is carried along at least a portion of one of the first and second major faces of the substrate and comprises a hydrophilic carbonaceous component and a hydrophobic component. The hydrophilic carbonaceous component comprises a low surface area carbon characterized by a surface area of below about 85 m²/g and a mean particle size of between about 35 nm and about 70 nm, with the understanding that the particle in question may actually be an agglomerate of particles.

In accordance with another embodiment of the present invention, the controller is configured such that operating conditions of the electrochemical cell are adjusted to produce a relative humidity of the humidified reactant output between about 100% and about 150%. The hydrophilic carbonaceous component comprises a moderate surface area carbon characterized by a surface area of between about 200 m²/g and about 300 m²/g and a mean particle size of between about 15 nm and about 40 nm.

In accordance with yet another embodiment of the present invention, the controller is configured such that operating conditions of the electrochemical cell are adjusted to produce a relative humidity of the humidified reactant output below about 100%. The hydrophilic carbonaceous component comprises a high surface area carbon characterized by a surface area of above about 750 m2/g and a mean particle size of less than about 20 nm.

In accordance with yet another embodiment of the present invention, a process for fabricating a diffusion media according to the present invention is provided wherein the operational relative humidity of the fuel cell is identified as low, moderate, or high and the diffusion media is tailored to the specific operational humidity of the fuel cell.

Accordingly, it is an object of the present invention to provide a means for addressing water management issues in diffusion media and devices employing such diffusion media. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of a fuel cell incorporating a porous diffusion media according to the present invention;

FIG. 2 is a schematic illustration of a porous diffusion media according to one embodiment of the present invention; and

FIG. 3 is a schematic illustration of a vehicle incorporating a fuel cell according to the present invention.

### DETAILED DESCRIPTION

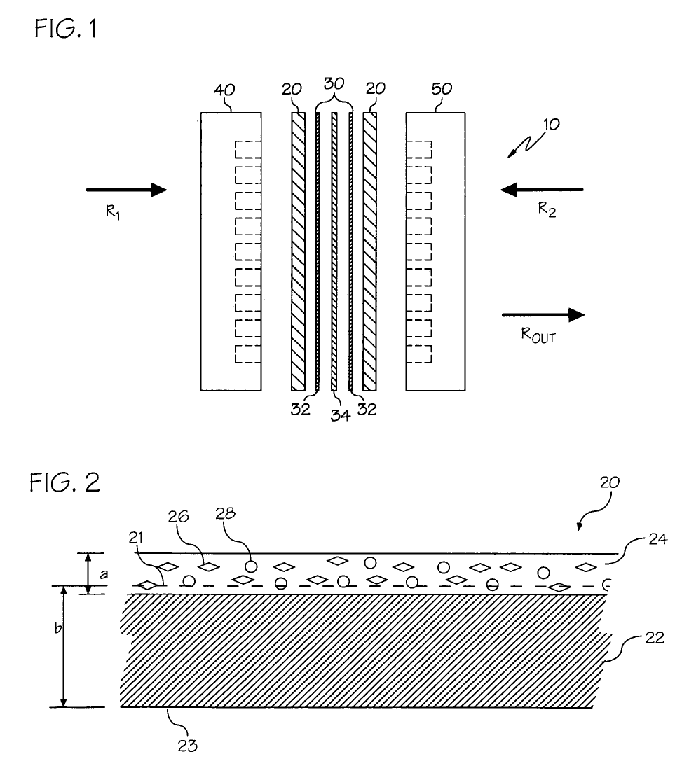

Referring initially to FIG. 1 a fuel cell 10 incorporating a porous diffusion media 20 according to the present invention is illustrated. Specifically, the fuel cell 10 comprises a membrane electrode assembly 30 interposed between an anode flow field 40 and a cathode flow field 50 of the fuel cell 10. It is contemplated that the flow fields 40, 50 and the membrane electrode assembly 30 may take a variety of conventional or yet to be developed forms without departing from the scope of the present invention. Although the particular form of the membrane electrode assembly 30 is beyond the scope of the present invention, in the illustrated embodiment, the membrane electrode assembly 30 includes respective catalytic electrode layers 32 and an ion exchange membrane 34.

Referring now to FIG. 2, a diffusion media 20 according to one embodiment of the present invention is illustrated schematically. The diffusion media 20 comprises a diffusion media substrate 22 and a mesoporous layer 24. The diffusion media substrate 22 comprises a porous fibrous matrix, e.g. carbon fiber paper, defining first and second major faces 21, 23 and an amount of carbonaceous material sufficient to render the substrate 22 electrically conductive. In the illustrated embodiment, the diffusion media substrate 22 carries the mesoporous layer 24 along the first major face 21 of the substrate 22. For the purposes of defining and describing the present invention, it is noted that mesoporous structures are characterized by pore sizes that can range from a few nanometers to hundreds of nanometers.

The mesoporous layer 24 comprises a hydrophilic carbonaceous component 28 and a hydrophobic component 26. The hydrophilic carbonaceous component 28 comprises a low surface area carbon. Suitable carbon particles include, for example, carbon black, graphite, carbon fibers, fullerenes and nanotubules. Commercially available carbon blacks include, but are not limited to, Vulcan XC72RT™ (Cabot Corp., Bilerica, Mass.), Shawinigan C-55™ 50% compressed acetylene black (Chevron Chemical Co., Houston, Tex.), Norit type SX1™ (Norit Americas Inc., Atlanta, Ga.), Corax L™ and Corax P™ (Degussa Corp., Ridgefield Park, N.J.), Conductex 975™ (Colombian Chemical Co., Atlanta, Ga.), Super ST™ and Super P™ (MMM Carbon Div., MMM nv, Brussels, Belgium), KetJen Black EC 600JD™ (manufactured by Ketjen Black International Co. and available from Akzo Nobel Chemicals, Inc., Chicago, Ill.), Black Pearls™ (Cabot Corp., Bilerica, Mass.). Specific embodiments of the present invention employ acetylene black having a surface area of about 60 m²/g to about 70 m²/g, Vulcan XC72™ having a surface area of about 250 m²/g, KetJen Black™ having a surface area of between about 800-1300 m²/g, and Black Pearls™ having surface areas above 1300 m²/g. In addition to the high surface area carbon, the hydrophilic carbonaceous component may comprise a minor portion of carbon graphite to enhance electrical conductivity.

The hydrophobic component 26 may comprise a fluorinated polymer, e.g., polytetrafluoroethylene (PTFE), polyvinylidene fluoride (PVDF), polyvinyl fluoride (PVF), a combination of fluorinated polymers, or any other suitable hydrophobic material or combination of materials.

Regarding the respective weight percentages of the respective hydrophilic and hydrophobic components, the mesoporous layer may comprise between about 80 wt % and about 95 wt % of the carbonaceous component or, more specifically, about 80 wt % of the carbonaceous component in high operational humidity applications and between about 90 wt % and about 95 wt % of the carbonaceous component in low operational humidity applications.

In many embodiments of the present invention the mesoporous layer 24 is more effective in addressing water management issues if it is positioned against the membrane electrode assembly 30 of the fuel cell 10, as opposed to being positioned to face the flow field of the cell. Nevertheless, it is contemplated that the diffusion media substrate 22 may carry the mesoporous layer 24 along either major face 21, 23 of the substrate 22 regardless of which face is positioned against the membrane electrode assembly 30. Further, the mesoporous layer 24 may cover all or a portion of the face along which it is carried. As is illustrated in FIG. 2, the mesoporous layer 24 at least partially infiltrates the diffusion media substrate 22. The extent of infiltration, illustrated schematically by showing the first surface 21 in phantom in FIG. 2, will vary widely depending upon the properties of the mesoporous layer 24 and the diffusion media substrate 22. In some embodiments of the present invention, it may be advantageous to configure the mesoporous layer such that it is more porous than the fibrous matrix of the diffusion media substrate.

The present invention is not directed to the specific mechanisms by which the fuel cell 10 converts a hydrogenous fuel source to electrical energy. Accordingly, in describing the present invention, it is sufficient to note that the fuel cell 10 includes, among other things, a first reactant input R₁, a second reactant input R₂, and a humidified reactant output R_{OUT}. The present inventor has recognized that the water management properties of the diffusion media 20 should be optimized because it passes multiphase reactants, i.e., reactant gases, liquids, and vapors, between the membrane electrode assembly 30 and the respective flow fields 40, 50 of the fuel cell 10.

A fuel cell controller, which is not shown in the figures because controllers are typically illustrated as block elements and because its particular configuration is not germane to the understanding of the present invention, controls many of the fuel cell operating conditions—including operational humidity. Examples of some of the operating conditions controlled by the controller are cell and saturation temperatures of the anode and cathode, pressure, stoichiometry of the gases, humidity, flow rates of the first and second reactant inputs, or combinations thereof. In any event, the controller may be configured such that the fuel cell 10 operates at high relative humidity (greater than about 150% relative humidity at the humidified reactant output of the fuel cell), moderate relative humidity (between about 100% and about 150% relative humidity), or low relative humidity (less than about 100% relative humidity) at the output stream.

A fuel cell tends to give the best performance if the inlet stream is fully humidified (i.e., if the inlet stream has a relative humidity of approximately 100%). Any fuel cell that runs with a fully humidified inlet conditions will have an exit relative humidity greater than 100% (i.e., there is liquid water along with fully humidified gas in the outlet stream). For example, relative humidity values over 100% at the outlet stream represent 100% water saturated gas plus any excess liquid water produced by the fuel cell reaction as compared to the relative humidity of inlet stream. Since gas is consumed from inlet to outlet, the quantity of water vapor that can be held in the gas stream is reduced, thereby condensing any additional water into the liquid phase at the outlet stream. In other words, oxygen gas is being consumed along the gas flow channel length while inlet humidification is being preserved and water is being produced leading to oversaturation at the outlet (i.e., 100% humidified water vapor plus excess liquid water).

The relative humidity at the outlet stream can be calculated by multiplying the molar fraction of water at the output by the total pressure and dividing this product by the total amount of water vapor pressure the gas can hold at that particular temperature (i.e., the dew point). For example, if the temperature is set at 80° C. at both the inlet and output by the controller, the corresponding dew point would be 47.35 kPa. The controller could set a total pressure of 100 kPa. Looking at the mass balance mole fractions table for these operating conditions, the molar fraction of water in the outlet stream would be 0.574. Therefore, the resulting relative humidity of the output stream would be (0.574)(100)/(47.35)=1.212, or 121.2%.

| Species | Inlet fuel | Inlet air | Outlet fuel | Outlet air |
|---|---|---|---|---|
| H₂ | 0.526 | — | 0.426 | — |
| CO₂ | 0.000 | — | 0.000 | — |
| H₂O | 0.474 | 0.474 | 0.574 | 0.574 |
| O₂ | — | 0.111 | — | 0.050 |
| N₂ | — | 0.416 | — | 0.376 |
| Sum | 1 | 1 | 1 | 1 |

In another example, if the pressure is set to be 270 kPa and the temperature 60° C. by the controller, the dew point is 19.91 kPa. Looking at the mass balance mole fractions table below for these operating conditions, the molar fraction of water in the output stream is 0.226. Therefore, in this example, the resulting relative humidity of the output stream would be (0.226)(270)/(19.91) 3.068, or 306.8%.

| Species | Inlet fuel | Inlet air | Outlet fuel | Outlet air |
|---|---|---|---|---|
| H₂ | 0.926 | — | 0.774 | — |
| CO₂ | 0.000 | — | 0.000 | — |
| H₂O | 0.074 | 0.074 | 0.226 | 0.226 |
| O₂ | — | 0.195 | — | 0.091 |
| N₂ | — | 0.732 | — | 0.683 |
| Sum | 1 | 1 | 1 | 1 |

Alternatively, the relative humidity of the outlet stream can be measured if the outlet stream is allowed to fully condense. It is to be understood, that the fuel cell is not operating at steady state at a relative humidity of greater than 100%. The outlet stream values of greater than 100% relative humidity are a relative value as compared to operating conditions. The controller (in this case) keeps the pressure and temperature constant and the same at the inlet and outlet in order to maintain the 100% saturated gas. Coolant may be used to maintain the constant temperature at both the inlet and outlet as known in the art.

According to the present invention, various parameters of the diffusion media 20 are tailored to the specific operational humidity of the fuel cell. Of course, in the event humidity regulation elements are employed in the fuel cell device downstream of the diffusion media and prior to the humidified reactant output, the relative humidity measures expressed herein are given as if such humidity regulation elements are not present in the device.

The following table represents approximate suitable values for selected parameters of the diffusion media substrate 22 and the mesoporous layer 24 of the diffusion media as a function of the operational humidity of the fuel cell 10:

| | High RH | Medium RH | Low RH |
|---|---|---|---|
| Parameter | (>150%) | (100% to 150%) | (<100%) |
| Surface area of Carbonaceous Component | .85; 60-80 | 200-300; 250 | /750; 800-1300 |
| (m²/g) | | | |
| Size of Carbonaceous Component | 35-70; 42 | 15-40; 30 | .20 |
| (mean particle size; nm) | | | |
| Amount of Carbonaceous Component | 80; .80 | /80 | /80; 90-95 |
| (Volumetric wt %) | | | |
| Substrate Pore Size | /25; 25-30 | 20-30 | .25 |
| (mean, size distribution; μm) | | | |
| Substrate Porosity | /80 | 70-80 | 70-75 |
| (% volumetric occupation) | | | |
| Mesoporous Layer Thickness, [symbol] | .15; 10-12 | 10-20 | 10-40 |
| (μm) | | | |
| Mesoporous Layer Infiltration | .5 | .10 | .25; 20-25 |
| (μm) | | | |
| Substrate Thickness, [symbol] | 100-300 | 150-300 | 190-300 |
| (μm) | | | |

As is illustrated in the table, carbonaceous components 28 of relatively low surface area are more suitable for operation under high operational humidity. A diffusion media 20 including relatively low surface area carbons will be better suited than higher surface area carbons to wick water away from the membrane electrode assembly 30 of the fuel cell 10. The larger percentage of micropores associated with the high surface area carbons make it more difficult to wick water away from the membrane electrode assembly but also make the diffusion media better suited for operation under low humidity. For similar reasons, carbonaceous components 28 of relatively larger particle sizes are better suited than smaller particle sizes under high operational humidity. The volumetric weight percentage of the carbonaceous component 28 in the mesoporous layer 24 may also be increased or decreased to account for the demands associated with the operational humidity of the fuel cell 10. Approximate values for these parameters, at each range of operational humidity, are given in the table above.

The generally increasing values associated with the substrate pore size as humidity increases represents the fact that the porosity of the substrate should be lower at low operational humidity and higher at high operational humidity as water transfer demands become more significant. Similarly, the dimensional thickness [symbol] of the substrate 22 should be larger at relatively low operational humidity to increase the water storage capacity of the diffusion media 20. Regarding the mesoporous layer 24, its dimensional thickness [symbol] and degree of infiltration into the substrate 22 are generally more restricted under relatively high operational humidity. Approximate values for these parameters, at each range of operational humidity, are also given in the table above.

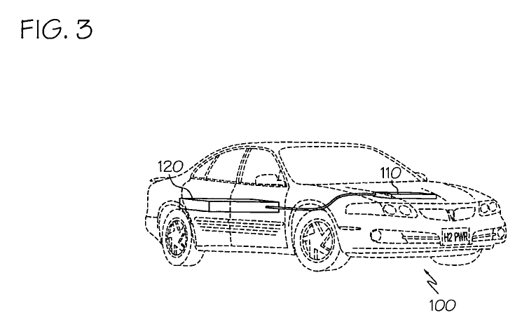

Referring now to FIG. 3, a fuel cell system incorporating diffusion media according to the present invention may be configured to operate as a source of power for a vehicle 100. Specifically, fuel from a fuel storage unit 120 may be directed to the fuel cell assembly 110 configured to convert fuel, e.g., H₂, into electricity. The electricity generated is subsequently used as a motive power supply for the vehicle 100 where the electricity is converted to torque and vehicular translational motion.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise a diffusion media, a fuel cell incorporating a diffusion media according to the present invention, a vehicle incorporating a fuel cell according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A device configured to convert a hydrogenous fuel source to electrical energy, said device comprising a controller, a first reactant input, a second reactant input, a humidified reactant output, and a diffusion media configured to pass multiphase reactants wherein:
a relative humidity of said humidified reactant output exceeds about 150%;
said diffusion media comprises a diffusion media substrate and a mesoporous layer;
said diffusion media substrate comprises a carbonaceous porous fibrous matrix defining first and second major faces;
said mesoporous layer is carried along at least a portion of one of said first and second major faces of said substrate and comprises a hydrophilic carbonaceous component and a hydrophobic component;
said hydrophilic carbonaceous component comprises a low surface area carbon characterized by a surface area of below about 85 m²/g and a mean particle size of between about 35 nm and about 70 nm.

2. A device as claimed in claim 1 wherein said hydrophilic carbonaceous component comprises a low surface area carbon characterized by a surface area of between about 60 m²/g and about 80 m²/g.

3. A device as claimed in claim 1 wherein said hydrophilic carbonaceous component comprises a low surface area carbon characterized by a mean particle size of about 42 nm.

4. A device as claimed in claim 1 wherein said mesoporous layer comprises between about 90 wt % and about 95 w % of said carbonaceous component.

5. A device as claimed in claim 1 wherein said mesoporous layer defines a thickness of about 10 μm to about 12 μm.

6. A device as claimed in claim 1 wherein said mesoporous layer at least partially infiltrates said diffusion media substrate.

7. A device as claimed in claim 1 wherein said mesoporous layer is characterized by a porosity greater than a porosity of said fibrous matrix of said diffusion media substrate.

8. A device as claimed in claim 7 wherein said substrate is characterized by a porosity of above about 80%.

9. A device as claimed in claim 1 wherein said substrate is characterized by a mean pore size of between about 25 μm and about 35 μm.

10. A device as claimed in claim 1 wherein:
said hydrophilic carbonaceous component comprises acetylene black characterized by a surface area of between about 60 m2/g and about 80 m2/g;
said mesoporous layer comprises less than about 80 wt % of said carbonaceous component;
said hydrophobic component comprises a fluorinated polymer selected from PTFE, PVDF, PVF, and combinations thereof;
said mesoporous layer defines a thickness of less than about 15 μm; and
said diffusion media substrate comprises carbon fiber paper characterized by a porosity of above about 80% and defining a thickness of between about 100 μm and about 300 μm; and
said controller is configured to regulate temperature, pressure, humidity, and flow rates of said first and second reactant inputs such that said relative humidity of said humidified reactant output exceeds about 150%.

11. A device configured to convert a hydrogenous fuel source to electrical energy, said device comprising a first reactant input, a second reactant input, a humidified reactant output, a diffusion media configured to pass multiphase reactants within said device wherein:
a relative humidity of said humidified reactant output is between about 100% and about 150%;
said diffusion media comprises a diffusion media substrate and a mesoporous layer;
said diffusion media substrate comprises a carbonaceous porous fibrous matrix defining first and second major faces;
said mesoporous layer is carried along at least a portion of one of said first and second major faces of said substrate and comprises a hydrophilic carbonaceous component and a hydrophobic component; and
said hydrophilic carbonaceous component comprises a moderate surface area carbon characterized by a surface area of between about 200 m²/g and about 300 m²/g and a mean particle size of between about 15 nm and about 40 nm;
wherein said mesoporous layer infiltrates said diffusion media substrate to a depth of less than 10 μm.

12. A device as claimed in claim 11 wherein said hydrophilic carbonaceous component comprises a moderate surface area carbon characterized by a surface area of about 250 m²/g.

13. A device as claimed in claim 11 wherein said hydrophilic carbonaceous component comprises a low surface area carbon characterized by a mean particle size of about 30 nm.

14. A device as claimed in claim 11 wherein said mesoporous layer defines a thickness of between about 10 μm and about 20 μm.

15. A device as claimed in claim 11 wherein said substrate comprises carbon fiber paper characterized by a porosity of between about 70% and about 80%.

16. A device as claimed in claim 15 wherein said carbon fiber paper defines a thickness of between about 150 μm and about 300 μm.

17. A device as claimed in claim 11 wherein said substrate is characterized by a mean pore size of between about 20 μm and about 30 μm.

18. A device as claimed in claim 11 wherein said mesoporous layer comprises greater than about 80 wt % of said carbonaceous component.

19. A device according to claim 11 wherein the carbonaceous porous fibrous matrix of the diffusion media substrate has a greater porosity than the mesoporous layer.

20. A device configured to convert a hydrogenous fuel source to electrical energy, said device comprising a first reactant input, a second reactant input, a humidified reactant output, a diffusion media configured to pass multiphase reactants within said device wherein:
a relative humidity of said humidified reactant output is below about 100%;
said diffusion media comprises a diffusion media substrate and a mesoporous layer;
said diffusion media substrate comprises a carbonaceous porous fibrous matrix defining first and second major faces;
said mesoporous layer is carried along at least a portion of one of said first and second major faces of said substrate and comprises a hydrophilic carbonaceous component and a hydrophobic component; and
said hydrophilic carbonaceous component comprises a high surface area carbon characterized by a surface area of above about 750 m²/g and a mean particle size of less than about 20 nm.

21. A device as claimed in claim 20 wherein said hydrophilic carbonaceous component comprises a moderate surface area carbon characterized by a surface area of between about 800 m²/g and about 1300 m²/g.

22. A device as claimed in claim 20 wherein said mesoporous layer defines a thickness of between about 10 μm and about 40 μm.

23. A device as claimed in claim 20 wherein said mesoporous layer infiltrates said diffusion media substrate to a depth of between about 20 μm and about 25 μm.

24. A device as claimed in claim 20 wherein said substrate comprises carbon fiber paper characterized by a porosity of between about 70% and about 75%.

25. A device as claimed in claim 20 wherein said carbon fiber paper defines a thickness of between about 190 μm and about 300 μm.
